(19) United States
(12) Patent Application Publication
(10) Pub. No.: US 2007/0003091 A1
(43) Pub. Date: Jan. 4, 2007

(54) Amplified and acoustic-coupling-compensated headphone and earbud system

(75) Inventor: Michael L. Petroff, Marina Del Rey, CA (US)

Correspondence Address: KEUSEY, TUTUNJIAN & BITETTO, P.C., 20 CROSSWAYS PARK NORTH, SUITE 210, WOODBURY, NY, 11797, US

(73) Assignee: ELECTROSOURCE LLC

(21) Appl. No.: 11/129,259

(22) Filed: May 13, 2005

Related U.S. Application Data
(60) Provisional application No. 60/631,117.

(51) Int. Cl. H04R 25/00

(52) U.S. Cl. 381/370

(57) ABSTRACT

A dedicated stereophonic bridged type amplifier and headphone or earbud system in which the amplifier provides at least one of low frequency compensations and high frequency compensations calibrated to substantially match the coefficients of acoustic coupling for the corresponding headphones or earbuds. In preferred embodiments, the dedicated amplifier is integrated into the headphone or earbud body(s), head strap or audio input cable as applicable.

### CROSS REFERENCE TO RELATED APPLICATIONS

This application claims priority from U.S. Provisional Application Ser. No. 60/631,117, filed Nov. 24, 2004, which is incorporated herein by reference.

### BACKGROUND OF THE INVENTION

1. Field of the Invention

The present invention relates to headphones and earbuds. More particularly, it relates to bridge amplifier driven acoustic coupling compensated headphones and earbuds for optimal sound reproduction accuracy.

2. Description of the Prior Art

Headphones fall into two basic categories—“open air” or on-the-ear type, and “cup” or over-the-ear type, each having left and right headphone bodies, left and right transducers incorporating left and right transducers respectively, and an audio input cable. On-the-ear headphones generally include a pair of substantially flat surfaced, acoustically transparent (open air) cushions disposed over the left and right transducers of the headphones, which press against, but do no envelop, the corresponding outer ears of a listener. Over-the-ear headphones generally include a pair of ear cups disposed over the left and right transducers of the headphones, which substantially envelop the corresponding outer ears of a listener.

The open air cushions in on-the-ear headphones do not form air tight fits to the ears, and, it has been determined by the inventor, therefore exhibit a low frequency ‘coefficient of acoustic coupling’ to the ear that is approximately unity between 150 Hz and 7 kHz, and decreases as a function of frequency below 150 Hz. Additionally, the diameters of such transducer diaphragms are typically significantly larger than the exposed openings of the ear canals, and therefore provide a high frequency coefficient of acoustic coupling to the ear that decreases as a function of frequency above substantially 7 kHz.

Variances in the 150 Hz and 7 kHz frequency points and the magnitude of required compensation, occur as a function of several influencing factors, including: 1) the electro-acoustic characteristics and frequency response of the transducers; 2) physical size of the diaphragms; 3) shape and density of the open air cushions; and 4) pressure between the air cushions and the ears.

Contrary to conventionally held assumptions in the field, even very high quality on-the-ear headphones require compensation of low and/or high frequency coefficients of acoustic coupling in accordance with the above described influencing factors, for optimal sound reproduction accuracy.

A dedicated amplifier having low and high frequency compensation calibrated to substantially match the coefficients of acoustic coupling for a specific on-the-ear headphone design is therefore required for optimal sound reproduction accuracy. As a practical matter, such dedicated amplifier is best integrated in-line with the headphone input cable.

The ear cups comprised in over-the-ear headphones form more air tight, although not perfect, fits to the ears than that provided by on-the-ear headphones. It has been determined that over-the-ear headphones also exhibit a low frequency coefficient of acoustic coupling to the ear that decreases as a function of frequency below 100 Hz, however, generally to a less severe extent than that of on-the-ear headphones. The over-the-ear headphones also provide a high frequency coefficient of acoustic coupling to the ear that decreases as a function of frequency above 7 kHz, each for the same reasons and subject to the same variances as identified above for on-the-ear headphones. Over-the-ear headphones therefore also require a dedicated amplifier having specific low and high frequency calibrations for optimal sound reproduction.

Similarly, earbuds (or earphones) exhibit low and high frequency coefficients of acoustic coupling to the ear, and therefore require a dedicated amplifier having specific low and high frequency calibrations for optimal sound reproduction accuracy. Variances in the low frequency coefficients of acoustic coupling for earbuds, however, can be quite large relative to that of headphones and is a function of physical design and ear fitting effectiveness. Variances in the high frequency coefficients of acoustic coupling in earbuds occur for various reasons, including sound direction misalignments and/or resonances occurring between the earbud diaphragms and the ear canals.

A unique earbud design described in specific embodiments of the present invention optimizes both such variances by means of a transducer diaphragm having a diameter substantially larger than an output tube that is acoustically coupled to the diaphragm through a coupling channel. The radial center of the output tube is misaligned with the radial center of the diaphragm in order to position the transducers of the earbuds further from the listener's head. The acoustically confining surfaces of the coupling channel are, at least to a limited extent, non-parallel to the radial axis of the diaphragm. The output tube fits into the ear canal opening and preferably comprises a pliable solid or hollow annulus about its diameter and near its open end to facilitate a comfortable fit to the ear.

As is the case for conventional earbuds, the earbuds of the present invention insert into the ear canals of a listener, and have left and right transducers and an audio input cable, but do not include a head strap. A dedicated bridged type amplifier having low and/or high frequency compensation calibrated to substantially match the coefficients of acoustic coupling for a specific earbud design, such as the above unique earbud design, is required for optimal sound reproduction accuracy. As a practical matter, such dedicated amplifier is best integrated in-line with the earbud input cable.

A unique dedicated amplifier as applies to driving headphones or earbuds is described in several embodiments of the present invention, and includes a stereophonic pair of bridged amplifier output stages having + and − output signals that are generally direct coupled (no coupling capacitors) to the left and right transducers of a pair of corresponding headphones and earbuds, wherein such amplifier incorporates low and/or high frequency compensation of the coefficients of acoustic coupling for the corresponding headphones or earbuds. In another embodiment, the dedicated amplifier may be used with various headphones and earbuds, and comprises selectable low and/or high frequency calibrations matched to at least two specific and differing headphone/earbud models.

### SUMMARY OF THE INVENTION

The present invention is a dedicated bridged type amplifier, having + and − outputs for each stereophonic channel, and headphone or earbud system in which the amplifier provides low and/or high frequency compensation calibrated to substantially match the coefficients of acoustic coupling for the corresponding headphone or earbud. Such dedicated amplifier is integrated in-line with the audio input cable of such headphone or earbud.

A unique earbud design described in the present invention comprises left and right earbud bodies, left and right transducers and an audio input cable. Each transducer comprises a diaphragm having a diameter substantially larger than an output tube that acoustically couples the diaphragm to a corresponding ear canal of a listener. The radial center of the output tube is substantially misaligned with the radial center of the diaphragm in order to position the output tube at an angle that is conducive to deep insertion into the listener's ear canal. The output tube preferably comprises a pliable solid or hollow annulus about its diameter and near its open end to facilitate a comfortable fit to the ear.

A unique dedicated amplifier as applies to driving headphones or earbuds is described in several embodiments of the present invention, and comprises a stereophonic pair of bridged amplifier output stages having + and − output signals that are generally direct coupled (no coupling capacitors) to the left and right transducers of a pair of corresponding headphones and earbuds, wherein such amplifier incorporates low and/or high frequency compensation of the coefficients of acoustic coupling for the corresponding headphones or earbuds. Bridged amplifiers are not used in prior art headphone or earbud in-line cable applications because such amplifiers require separate left and right ground lines and therefore cannot drive common ground input cables and connectors used in commercially available earbuds and headphones. Since the bridged amplifier of the present invention is dedicated and integrated in-line with corresponding headphones or earbuds, separate left and right ground lines may be utilized between such amplifier output signals and the left and right transducers, while the necessary conventional input cable and connector having a common ground may is utilized as input to the amplifier. Alternatively, unconventional male and female audio connectors and cables, each having at least four electrical contacts, may be used to couple between the dedicated amplifier and the left and right transducers. In another embodiment, the dedicated amplifier comprises selectable low and/or high frequency calibration matched to at least two specific headphone and/ or earbud models.

Other combinations and equivalent variations of the above described concepts and embodiments may be practiced by those skilled in the art without altering the general principles of the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of prior art headphones driven by a typical audio source and interconnected by a conventional 3-conductor connector;

FIG. 2 is a block diagram of the headphones and dedicated bridged amplifier driven by a typical audio source according to an embodiment of the present invention;

FIG. 3 is a block diagram of the headphones and dedicated bridged amplifier, according to an embodiment of the invention, interconnected by an unconventional 4-conductor audio connector and driven by a typical audio source;

FIG. 4 is a block diagram of prior art earbuds driven by a typical audio source and interconnected by a conventional 3-conductor audio connector;

FIG. 5 is a block diagram of the earbuds and dedicated bridged amplifier of the present invention driven by a typical audio source;

FIG. 6 is a block diagram of the earbuds and dedicated bridged amplifier of the present invention interconnected by an unconventional 4-conductor audio connector and driven by a typical audio source;

FIG. 7 is an illustration of the preferred embodiment of the earbud design of the present invention;

FIG. 8 is a block diagram of the first embodiment of the dedicated bridged amplifier of the present invention for use with one specific headphone or earbud design or model; and

FIG. 9 is a block diagram of the second embodiment dedicated amplifier of the present invention for selectable use with at least two specific headphone or earbud designs or models.

### DETAILED DESCRIPTION OF PREFERRED EMBODIMENTS

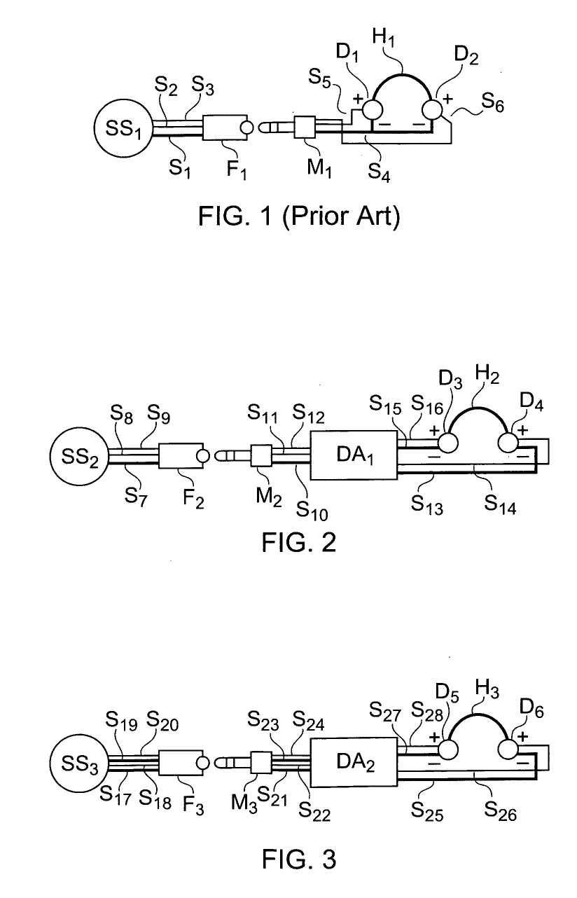

FIG. 1 is a block diagram of prior art headphones H1 driven by typical audio source SS1, in which headphones H1 do not include a dedicated or integrated amplifier. Audio source SS1 provides source ground S1, source left signal S2, and source right signal S3 to conventional 3-conductor female audio connector F1. Conventional 3-conductor male audio connector M1 couples to connector F1 and provides connector ground S4 applied to the − inputs of left driver D1 of headphones H1 and right driver D2 of headphones H1 respectively, connector left signal S5 to the + input of driver D1, and connector right signal S6 to the + input of driver D2.

FIG. 2 is a block diagram of headphones H2 and dedicated bridged stereo amplifier DA1 of the present invention, in which DA1 is driven by typical audio source SS2 and introduces compensation for at least one coefficient of acoustic coupling matched to headphones H2. Audio source SS2 provides source ground S7, left source signal S8, and right source signal S9 to conventional 3-conductor female connector F2. Conventional 3-conductor male connector M3 couples to connector F2 and provides connector ground S110, and connector left and right signals S11 and S12 respectively to corresponding stereo inputs of amplifier DA1. DA1 provides left output ground S15 to the − input of left driver D3 of headphones H2, left output signal S16 to the + input of driver D3, right output ground S13 to the − input of right driver D4 of headphones H2, and right output signal S14 to the + input of driver D4.

FIG. 3 is a block diagram of headphones H3 and dedicated bridged stereo amplifier DA2 of the present invention, in which DA2 is driven by atypical audio source SS3 that does not have common stereo ground outputs. Amplifier DA2 introduces compensation for at least one coefficient of acoustic coupling matched to headphones H3. Audio source SS3 provides left source ground S17, left source signal S18, right source ground S19, and right source signal S20 to unconventional 4-conductor female audio connector F3. Unconventional 4-connector male audio connector M3 couples to connector F3 and provides left connector ground S23, left connector signal S24, right connector ground S21, and right connector signal S22 to corresponding stereo inputs of amplifier DA2. Amplifier DA2 provides left output ground S27 to the − input of left driver D5 of headphones H3, left output signal S28 to the + input of driver D5, right output ground S25 to the − input of right driver D6 of headphones H3, and right output signal S26 to the + input of D5.

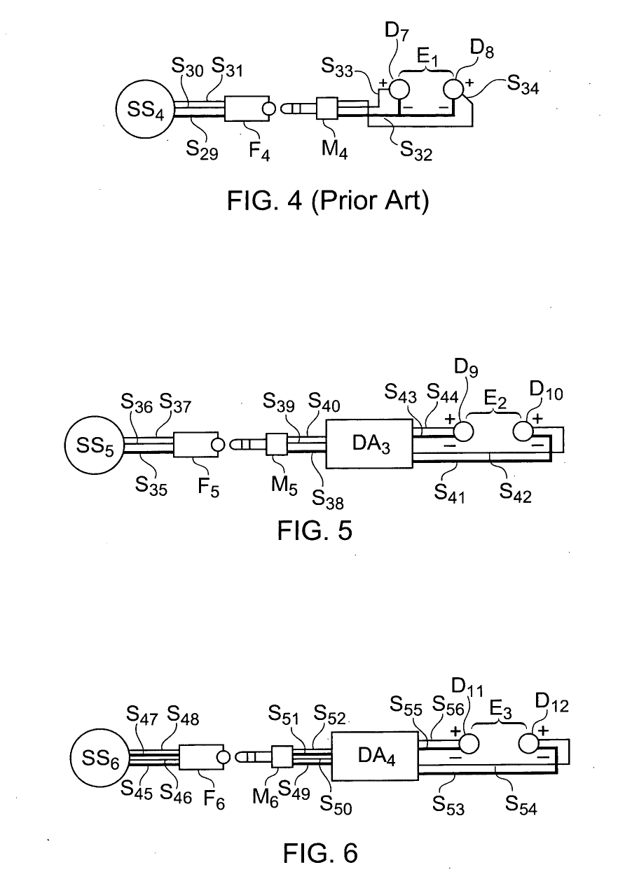

FIG. 4 is a block diagram of prior art earbuds E1 driven by typical audio source SS4, in which earbuds E1 do not include a dedicated or integrated amplifier. Audio source SS4 provides source ground S29, source left signal S30, and source right signal S31 to conventional 3-conductor female connector F4. Conventional 3-conductor male connector M4 couples to connector F4 and provides connector ground S32 applied to the − inputs of left driver D7 of E1 and right driver D8 of E1 respectively, connector left signal S33 to the +input of D7, and connector right signal S34 to the + input of driver D8.

FIG. 5 is a block diagram of earbuds E2 and dedicated bridged stereo amplifier DA3 according to an embodiment of the present invention, in which DA3 is driven by typical audio source SS5 and introduces compensation for at least one coefficient of acoustic coupling matched to earbuds E2. Audio source SS5 provides source ground S35, left source signal S36, and right source signal S37 to conventional 3-conductor female connector F5. Conventional 3-conductor male connector M5 couples to connector F5 and provides connector ground S38, and connector left and right signals S39 and S40 respectively to corresponding stereo inputs of amplifier DA3. DA3 provides left output ground S43 to the − input of left driver D9 of earbuds E2, left output signal S44 to the + input of driver D9, right output ground S41 to the − input of right driver D9 of earbuds E2, and right output signal S42 to the + input of driver D9.

FIG. 6 is a block diagram of earbuds E3 and dedicated bridged stereo amplifier DA4 according to an embodiment of the present invention, in which DA4 is driven by atypical audio source SS6 not comprising common stereo ground outputs, and introduces compensation for at least one coefficient of acoustic coupling matched to earbuds E3. Audio source SS6 provides left source ground S47, left source signal S48, right source ground S45, and right source signal S46 to unconventional 4-conductor audio female connector F6. Unconventional 4-connector male audio connector M6 couples to connector F6 and provides left connector ground S51, left connector signal S52, right connector ground S49, and right connector signal S50 to corresponding stereo inputs of amplifier DA4. DA4 provides left output ground S55 to the − input of left driver D11 of earbuds E3, left output signal S56 to the + input of driver D11, right output ground S53 to the − input of right driver D12 of earbuds E3, and right output signal S54 to the + input of driver D12.

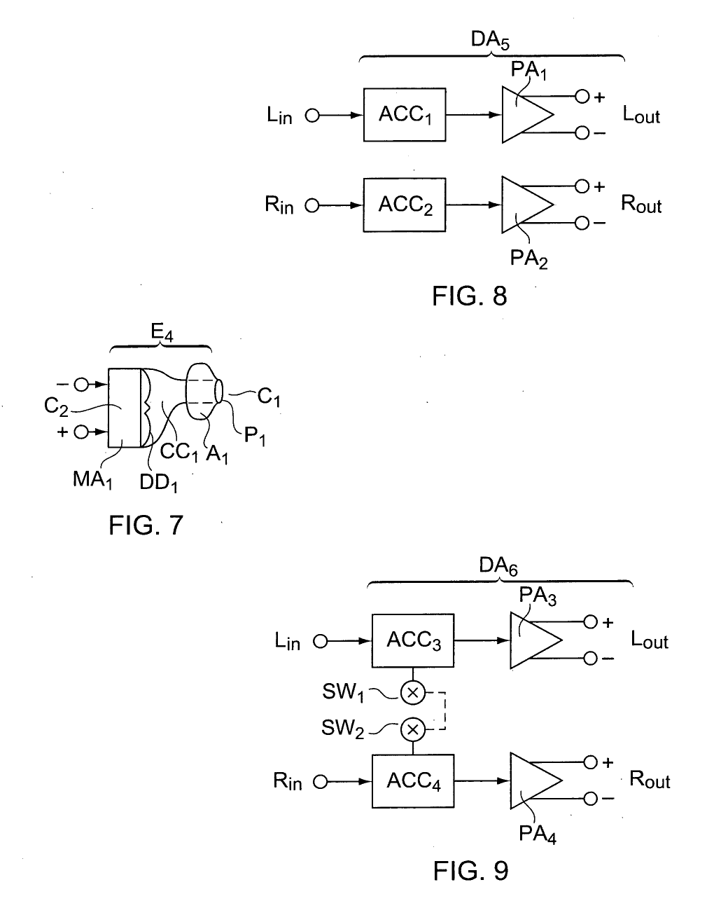

FIG. 7 is an illustration of earbud E4 according to a preferred embodiment of the present invention. Earbud E4 includes a magnetic assembly MA1 having + and − input terminals, and which drives driver diaphragm DD1. Sounds produced by DD is coupled by collection chamber CC1, which collects sound produced by diaphragm DD1, to output port P1. The axial center c1 of P1 is asymmetrically aligned with the axial center c2 of DD1, thereby comfortably displacing the earbud from the outer ear when inserted into the ear canal of a listener. P1 is surrounded by annulus A1 for comfortable fitting to the ear canal.

FIG. 8 is a block diagram of dedicated bridged stereo amplifier DA5 for use with one specific headphone or earbud design according to an embodiment of the present invention. Amplifier DA5 includes left and right input signals Lin and Rin which are applied to acoustic compensation networks ACC1 and ACC2 respectively. The compensation networks ACC1 and ACC2 are calibrated to one specific headphone or earbud design. The outputs of ACC1 and ACC2 are applied to the inputs of left and right bridged amplifiers PA1 and PA2 respectively, which provide left and right + and − output signals to the left and right drivers of the intended headphone or earbud respectively. The left and right − output signals are independent and therefore do not constitute a common ground signal.

FIG. 9 is a block diagram of dedicated bridged stereo amplifier DA6 according to another embodiment of the present invention. Amplifier DA6 is used with a selected one of at least two specific headphone or earbud designs, and includes left and right input signals Lin and Rin which are applied to acoustic compensation networks ACC3 and ACC4 respectively. The compensation networks ACC3 and ACC4 are calibrated to a selected specific headphone or earbud design by means of ganged switches (or controls) SW1 and SW2, respectively. The outputs of ACC3 and ACC4 are applied to the inputs of left and right bridged amplifiers PA3 and PA4 respectively, which provide left and right + and − output signals to the left and right drivers of the intended headphone or earbud respectively, wherein the left and right − output signals are independent and therefore do not constitute a common ground signal.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. In combination, an amplifier and an on-the-ears stereo headphone system, the combination comprising:
headphones comprising:
left and right headphone bodies;
left and right transducers;
a pair of substantially flat surfaced acoustically transparent cushions disposed over the left and right transducers, said cushions pressing against ears of the user without enveloping the same;
an audio input cable electrically connected to said left and right transducers; and
a dedicated stereophonic bridge type amplifier driving said transducers and having + and − output signals for each stereophonic channel, said amplifier integrated into the audio input cable and providing at least one of low and high frequency compensation calibrated to substantially match coefficients of acoustic coupling for the headphones.

2. The combination according to claim 1, further comprising unconventional male and female audio connectors and cables each having at least four electrical contacts, coupled between said amplifier and the left and right transducers.

3. In combination, an amplifier and an over-the-ears stereo headphone system, the combination comprising:
headphones comprising:
left and right headphone bodies;
left and right transducers;
a pair of ear cups disposed over the left and right transducers, said ear cups substantially enveloping corresponding outer ears of a listener; and
an audio input cable;
a dedicated stereophonic bridged type amplifier driving said left and right transducers and having + and − output signals for each stereophonic channel, said amplifier integrated into the audio input cable and providing at least one of low and high frequency compensation calibrated to substantially match coefficients of acoustic coupling for the headphones.

4. The combination according to claim 3, further comprising unconventional male and female audio connectors and cable, each having at least four electrical conductors, coupled between the dedicated amplifier and the left and right transducers of the headphones.

5. An earbud system comprising:
left and right earbud bodies;
left and right transducers;
an audio input cable; and
a dedicated stereophonic bridged type amplifier driving said earbuds and having + and − output signals for each stereophonic channel, said amplifier integrated into the audio input cable and providing at least one of low and high frequency compensation calibrated to substantially match coefficients of acoustic coupling for the earbuds.

6. The earbud system according to claim 5, further comprising unconventional male and female audio connectors and cables, each having at least four electrical contacts, coupled between said dedicated amplifier and the left and right transducers of the earbuds.

7. The earbud system according to claim 5, wherein said left and right earbud transducers each further comprise:
a diaphragm having a first radial center and a first diameter; and
an output tube having a second radial center and a second diameter;
wherein said output tube acoustically couples the diaphragm to a corresponding ear canal of a listener;
wherein said first diameter is substantially larger than said second diameter and the first and second radial centers are substantially misaligned in order to position said output tube at an angle that is conducive to deep insertion into the listener's ear canal.

8. A dedicated stereophonic amplifier for use with various headphone and earbud models, the amplifier comprising at least one of selectable low frequency calibrations and selectable high frequency calibrations, such calibrations being matched to at least two specific and differing headphone/earbud models.

9. The amplifier according to claim 8, wherein unconventional male and female audio connectors and cables, each providing at least four electrical contact, coupled between the amplifier and left and right transducers of the headphones or earbuds.
